(19) United States
(12) Patent Application Publication
(10) Pub. No.: US 2007/0062857 A1
(43) Pub. Date: Mar. 22, 2007

(54) SPACER FOR USE IN FILTER MODULES

(75) Inventors: Gabriel POPA, Rodgau (DE); Jean SUIDUREAU, Saint-Germain-en-Laye (FR); Petra JOHANSSEN, Hamburg (DE); Georg REINHOLD, Kelkheim (DE)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hills, NY (US)

(21) Appl. No.: 11/533,445

(22) Filed: Sep. 20, 2006

Related U.S. Application Data
(63) Continuation of application No. PCT/EP05/03482, filed on Apr. 2, 2005.

(30) Foreign Application Priority Data
Apr. 5, 2005 (DE) 10 2004 017 796.1

(51) Int. Cl. B01D 63/00

(52) U.S. Cl. 210/321.83; 210/321.76; 210/321.85

(57) ABSTRACT

Spacers for filter modules which have the advantages of open-channel technology and which at the same time allow high packing densities, similar to those achieved with conventional spiral wound-type modules, are disclosed wherein the spacer is disposed between two layers of a filter material and comprises a sheet material having a gridlike structure, and having upper and lower surfaces defining an upper and lower bearing face for the layers of filter material, the sheet material consisting of a large number of webs interconnected at junction points, of which webs a first portion is disposed parallel to a first preferred direction and a second portion is disposed parallel to a second preferred direction intersecting the first preferred direction, and at least some of the webs have first web regions, which extend to the upper and/or lower bearing face(s), and at least a further portion of the webs has second web regions which are spaced from the upper and lower bearing faces, the second web regions extending over substantially the entire length of those webs.

### CROSS REFERENCE TO RELATED APPLICATIONS

This application is a continuation of international application number PCT/EP2005/003482, filed on Apr. 2, 2005, that claims the benefit of German patent application number 10 2004 017 796.1, filed on Apr. 5, 2004, both of which are incorporated herein by reference in their entireties.

### BACKGROUND OF THE INVENTION

The invention relates to a spacer for use in filter modules comprising two or more layers of a filter material, with a spacer layer being disposed between two successive layers of filter material.

Filter modules of this type are used, in the form of spiral wound-type modules or stacked modules, for a wide range of filtration tasks, for example for the treatment of industrial waste water, the treatment of industrial process water, the treatment of leachate from landfills or for desalination of seawater.

Hitherto, dimensionally stable plastic disks with a multiplicity of punctiform elevations or webs, on which filter cushions come to bear, on their surface have been used as spacers in stacked modules. A volume is then available between the surface of the disks and a filter cushion for the flow over the filter material. The disks have apertures, so that the medium flowing over them can flow over a plurality of filter cushions in series. These stacked modules operate on the basis of the principle of open-passage technology, i.e. the medium supplied can flow onto substantially the entire surface area of the filter material, and there are no or only minimal flow obstacles in the direction of flow. The open-passage technology means that stacked modules are not susceptible to fouling, but they do have a relatively low packing density, with the result that the module costs based on the filter area available are higher than in the case of spiral wound-type modules, for example.

Unlike stacked modules, spiral wound-type modules have hitherto been constructed in such a way that the spacer is constructed as a flexible grid or mesh structure. The spacers are formed in such a manner that webs which are in contact with the filter material form obstacles in the direction of flow, at which obstacles spaces where the through-flow is reduced and deposits accumulate are formed. The deposits of constituents of the medium that form are referred to as fouling. Furthermore, in conventional modules the webs form barriers which restrict the extent to which the modules can be cleaned, since sediment removed during cleaning cannot be discharged from the module on account of the obstacles. Furthermore, the surface area of the filter material is not fully utilized, since no filtration takes place at the bearing locations. On the other hand, spiral wound-type modules have a relatively high packing density and are less expensive than stacked modules, based on the filter area available.

Spacers for spiral wound-type modules are described, for example, in DE 100 51 168 A1.

### BRIEF SUMMARY OF THE INVENTION

It is an object of the present invention to propose spacers for filter modules which have the advantages of open-passage technology and at the same time allow high packing densities, similar to those achieved with conventional spiral wound-type modules. According to the invention, this object is achieved by a spacer as described in claim 1.

To avoid fouling at the spacer, it is crucial that spaces through which the flow is reduced and in which deposits can accumulate be avoided as far as possible. As seen in the direction of flow of the medium being filtered, the spacer layer should substantially not have any points of contact with the surface of the filter material, so that the tendency to fouling is minimized. This is made possible by the structure of the spacers in accordance with the invention. The spacers according to the invention can be used for the production of both stacked and spiral wound-type modules.

The advantages achieved according to the invention in detail are as follows:
the substantial to complete absence of dead zones minimizes the susceptibility to fouling;
the unimpeded flow through the feed passage improves the cleanability of the filter module, since it is possible to discharge sediment;
it is possible to treat water carrying relatively high levels of solids which it has not hitherto been possible to treat using spiral wound-type modules;
it is possible to reduce pressure losses by using optimized incoming flow conditions;
the promotion of turbulence makes it possible to reduce the concentration polarization;
it is possible to configure filter modules with an increased packing density compared to standard stacked-plate modules.

### DETAILED DESCRIPTION OF THE INVENTION

It is preferable for the web regions which are responsible for supporting the filter material on the spacer to be configured in the form of straight fins. In this case, it is generally possible to provide for the fins to extend over the entire length or the entire extent of the filter material, in particular the membrane, in particular if the webs are disposed substantially parallel to the direction of flow of the fluid being filtered.

The fins may be provided on the same web regions on the upper and lower sides of the spacer layer, so as to form a multiplicity of parallel flow passages.

One alternative consists in configuring the web regions which bear against the surface of the filter material in the form of punctiform or substantially punctiform regions, i.e. with a small area compared to the extent of the grid or mesh structure.

By way of example, it is possible to provide for the punctiform supporting regions of the webs to be formed at junction points of the webs.

All other regions of the grid structure then do not lead to contact with the surface regions of the filter materials and allow the fluid to flow through substantially unimpeded. This minimizes volumes with reduced flow through them as far as possible.

In a further alternative, the filter material layers are supported on the upper side of the spacer layer at one web region and on the lower side of the spacer layer at another web region. This allows flow onto the spacer layer even with web regions that are continuous in form, with the direction of flow forming an acute angle with the preferred directions.

In a further preferred embodiment, substantially all the webs are formed parallel to the preferred directions if they comprise web regions which serve to bear against the surfaces of the filter materials.

One of the preferred directions is preferably oriented substantially parallel to the direction of flow of the fluid being filtered.

Depending on the particular application, a more or less turbulent flow may be desired in the filter module. By way of example, turbulence is in some cases undesirable in applications in the food industry in which the concentrate represents the product, in order thereby to maintain the quality of the product.

On the other hand, in waste water applications, it is often desirable for the flow over the membrane to be as turbulent as possible, in order to further reduce the risk of fouling and scaling.

Webs or web regions which do not bear against the surface of the filter material and are kept at a distance therefrom are in certain applications preferably noncircular in cross section, i.e. in particular of an oblate shape, so that they form a minimal resistance to the incoming flow of the fluid.

For other applications, these or other web regions may preferably be disposed and/or formed in such a way that they produce regions of turbulence, thereby disrupting laminar flows at the membrane surface, with the result that fouling on the surface of the filter material can be avoided and concentration polarization at the surface of the filter material can also be broken up or avoided.

Concentration polarization is the regional increase in the concentration of substances in the region of the membrane surface, caused by the solvent being transported through the membrane.

Overall, the webs are preferably connected to one another and configured in such a way that they form flow channels whose cross section substantially approaches the shape of rectangles. The bearing surface of the web regions which bear against the surfaces of the filter materials will be as small as possible, in order to cover the minimum possible amounts of the filter material surface area available.

However, the bearing surface as a whole must not be too small, to avoid damage to the filter material surface, which could otherwise be caused by loads resulting from pressure fluctuations during the filtration operation. A cross section through the flow passages which is as far as possible rectangular ensures that the flow velocity is substantially uniform, as seen over the cross section of the passages, so that as much as possible of the available filter material surface area can be utilized uniformly and volumes with a reduced flow through them are avoided.

### BRIEF DESCRIPTION OF THE SEVERAL VIEWS OF THE DRAWINGS

These and further advantages of the invention are explained in more detail below with reference to the drawing, in which, in detail:

FIG. 1 shows a sectional view through a first embodiment of the filter module of the present invention;

FIG. 2 shows a plan view of the spacer according to the invention of the filter module shown in FIG. 1;

FIG. 3 shows an enlarged sectional view of a detail from FIG. 2;

FIG. 4 shows a sectional view through a further embodiment of the filter module according to the invention;

FIG. 5 shows a plan view of the spacer according to the invention of the filter module shown in FIG. 3;

FIG. 6 shows an enlarged sectional view of a detail from FIG. 5;

FIG. 7 shows a sectional view through a further embodiment of a filter module of the present invention;

FIG. 8 shows a plan view of the spacer according to the invention of the filter module shown in FIG. 7;

FIG. 9 shows an enlarged sectional view through a detail from FIG. 8;

FIG. 10 shows a sectional illustration through a further embodiment of the filter module according to the invention;

FIG. 11 shows a plan view of the spacer according to the invention from FIG. 10; and

FIG. 12 shows an enlarged sectional view of a detail from FIG. 11.

FIG. 1 shows a filter module, which is denoted overall by reference numeral 10 and comprises a first layer 12 of a filter material and a second layer 14 of the filter material, which are held spaced apart from one another by a spacer 16 disposed between them. The filter material layers 12 and 14 may consist of different filter materials, and may in particular also be in the form of membranes.

A filter cushion can be constructed from two layers of filter material with a spacer between them for discharging permeate. The three layers are welded or adhesively bonded to one another at the outer edges. The cushion shape and the number of joined sides depend on the desired filter module shape.

The spacer 16 (also referred to below as a spacer layer) is substantially assembled from webs to form a gridlike structure, with the webs disposed in two directions and connected to one another via junction points. In particular, in this case there are webs 18 which are disposed parallel to the direction of flow of a fluid being treated and which are held spaced apart from one another and connected to one another by means of transverse webs 20. On their surfaces facing upward and downward, the webs 18 have fins 22 and 24, which serve on the one hand to support the filter material layer 12 and on the other hand to support the filter material layer 14. They therefore include first web regions which define the bearing surfaces for the filter materials.

The transverse webs 20, by contrast, maintain a spacing both from the surface of the filter material layer 12 and from the surface of the filter material layer 14 and thereby avoid zones through which the flow is reduced, allowing the fluid being filtered to flow through substantially unimpeded. These represent the second web regions.

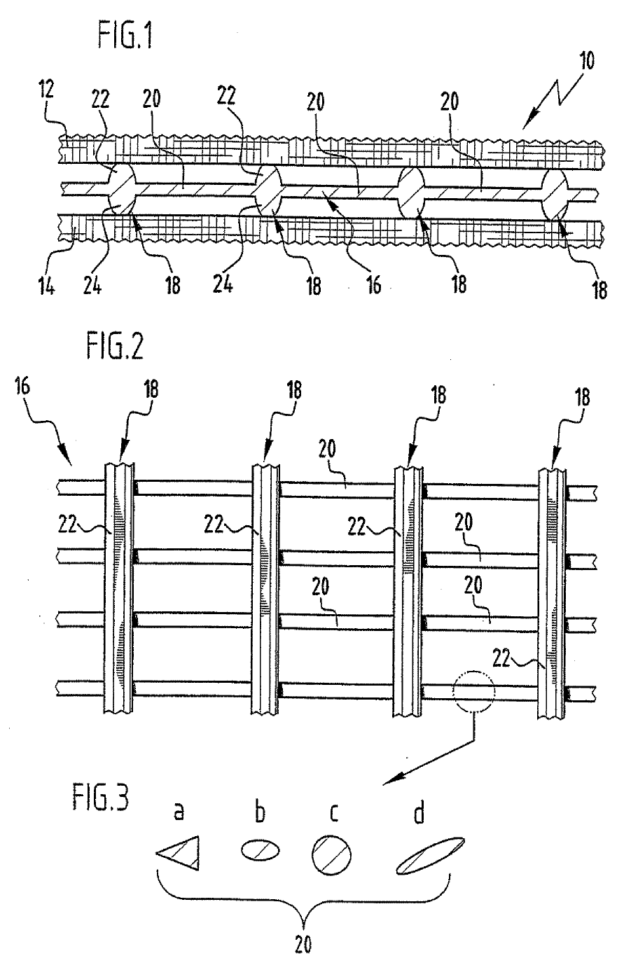

FIG. 2 provides a further, more detailed illustration of the mesh structure of the spacer layer 16, providing a clear and detailed illustration of the rectangular grid structure of the spacer layer 16. The webs 18, which continue endlessly, carry the abovementioned fins 22, which form a narrow bearing surface for the filter material layer 12, on their upper side. The transverse webs 20 hold the webs 18 spaced apart from one another and are in each case set back from the plane formed by the bearing surfaces of the fins 22.

A view from below is not shown here, since such a view would be substantially identical to the top view illustrated here.

Finally, FIG. 3 shows, in the form of a detail view, a number of variants a, b, c and d of a possible cross section through the webs 20; if noncircular webs 20 are used, depending on the particular application, the disposition of the webs opposite to the direction of flow of the fluid being filtered is selected in such a way that the area facing the incoming flow is as small as possible, or is selected in such a way that regions of turbulence are produced in the flow of the fluid. In the former case, the resistance to incoming flow is minimized, whereas in the latter case possible concentration polarization is inhibited.

In the latter case, the noncircular webs 20 will be disposed in such a way (cf. in particular variants a) and d)) that the liquid is diverted in one direction or the other by the webs 20, so that laminar flows at the filter material surfaces are broken up. This allows deposits on the surface of the filter material to be reduced or even avoided altogether and also makes it possible to counteract or avoid concentration polarization at the surface of the filter material.

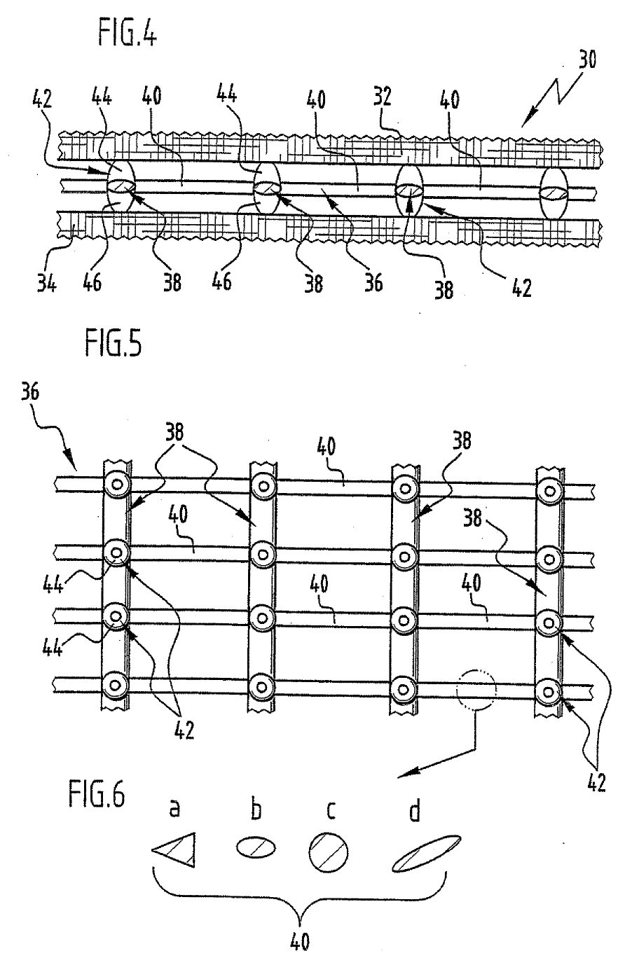

A further variant of a filter module according to the invention is illustrated in FIG. 4. The filter module 30 illustrated in FIG. 4 is of similar construction to the filter module 10 shown in FIG. 1. In this module, a first filter material layer 32 and a second filter material layer 34 are held spaced apart from and substantially parallel to one another by a spacer layer 36. The grid or mesh structure of the spacer layer 36 is once again constructed from longitudinal and transverse webs 38 and 40, respectively, resulting in a rectangular structure.

First web regions 42, which above and below the plane formed by the webs 38 and 40 carry studs 44 and 46, against which one or other filter material layer 32 or 34 then comes to bear, are provided at the junction points of the longitudinal and transverse webs 38, 40.

It can be seen from the plan view of the spacer layer 36 presented in FIG. 5 that the bearing points of the studs 44 (and this also applies to the downwardly facing studs 46) are relatively small, so that a maximum clear surface area of the filter material layers 32 and 34, respectively, results. Therefore, substantially almost all the web regions count as second web regions, which maintain a spacing from the filter material layers 32 and 34.

Once again, various possibilities are available for the configuration of the transverse webs 40, and these possibilities are illustrated as variants a, b, c and d in FIG. 6. The statements which have been made in connection with the filter module 10 apply once again with regard to the selection of the geometry of the cross section of the transverse webs 40 and the orientation thereof.

The remaining form of the longitudinal webs 38 is substantially independent of the shape of the transverse webs 40, in particular including in cross section. In this case too, as can be seen for example from FIG. 4, it is possible to provide an elliptical cross section, so that on the one hand the stability of the grid structure is maintained, but on the other hand the maximum possible spacing of these webs too from the surfaces of the filter material layers 32 and 34 is maintained. This ensures that even in the surface regions of the filter material layers 32 and 34, between which the longitudinal webs 38 are disposed, there are no small volumes in which deposits could occur, associated with subsequent fouling.

FIGS. 7 to 9 describe a further variant of the present invention, the basic structure of which is similar to the embodiment shown in FIGS. 1 to 3.

The embodiment shown here relates to a filter module 50 in which a first filter material layer 52 and a second filter material layer 54 are held parallel to and at a spacing from one another by a spacer layer 56 disposed between them. The spacer layer 56 is once again formed by longitudinal webs 58 and transverse webs 60.

As in the embodiment shown in FIGS. 1 to 3, in the embodiment of a filter module shown here, the spacer 56 is constructed from continuous longitudinal webs 58, which are lined up rectilinearly next to one another and carry fins 62, 64 at their upper and lower sides, as can be seen most easily from FIG. 8. They represent first web regions which define the bearing surfaces for the filter materials. In the filter module shown here in FIGS. 7 to 9, the transverse webs 60 of the spacer are disposed differently compared to the embodiment of the filter module shown in FIGS. 1 to 3. These transverse webs 60 do not run substantially parallel to the surfaces of the filter material layers 52 and 54, but rather are disposed running at an angle to these surfaces and connect two longitudinal webs 58 disposed parallel to one another, linking to a fin 64 located at the bottom and ending in a fin 62 located at the top, of the adjacent longitudinal web 58, or in the reverse orientation. The transverse web 60 located downstream as seen in the direction of flow will preferably have precisely the reverse form of linking between the two longitudinal webs 58 running next to one another, so that in the view illustrated in FIG. 7 the transverse webs as it were cross one another. This results in a particularly effective disruption, so that deposits or concentration polarization can be avoided at the surface of the filter material layers. In this exemplary embodiment, the transverse webs form the second web regions.

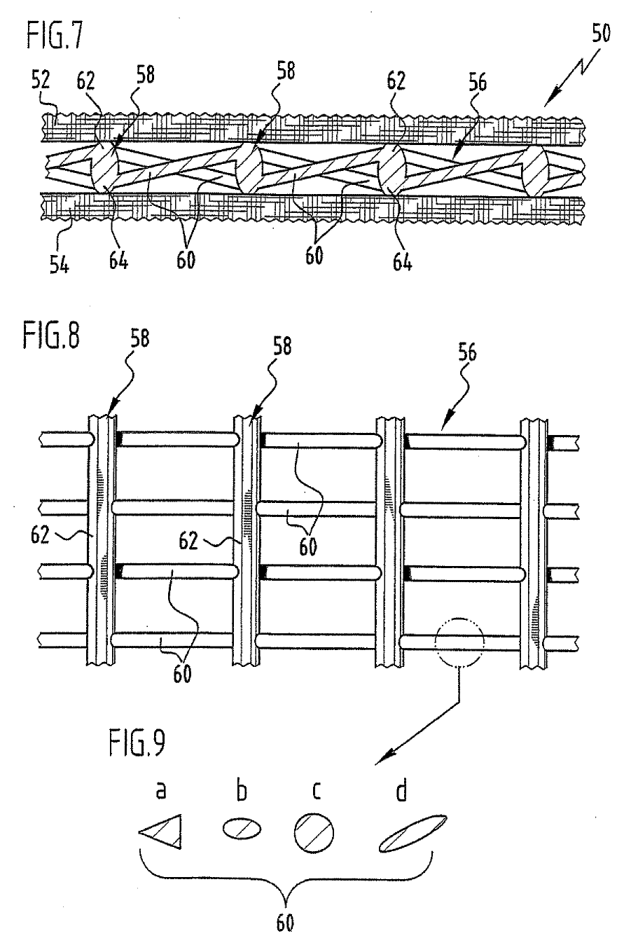

FIG. 9 once again shows possible modifications a, b, c and d of the cross sections of the transverse webs 60, and the comments made with regard to these different cross sections correspond to what has already been stated in connection with FIG. 3.

Finally, FIGS. 10 to 12 show a further embodiment of the present invention, with a structure similar to that shown in FIGS. 4 to 6.

The filter module 70 illustrated once again comprises two filter material layers 72 and 74, which are held parallel to and spaced apart from one another by a spacer layer 76. Similarly to the embodiment shown in FIGS. 4 to 6, both the longitudinal webs and the transverse webs maintain a spacing from the surfaces of the filter material layers 72 and 74. The longitudinal webs 78 and the transverse webs 80 (second web regions) are connected to one another via junction points 82, at which studs 84 and 86 for punctiform support of the filter material layers 72 and 74 (first web regions) are formed on the upper and lower sides of the spacer layer. As in the embodiment shown in FIGS. 6 to 9, the transverse webs 80 run obliquely from the bottom upward, i.e. they connect a stud 86 at a junction point of a longitudinal web 78 to a stud 84 located above it of an adjacent longitudinal web 78 or vice versa, so that in the plan view shown in FIG. 10 the transverse webs 80 located behind one another as it were cross one another.

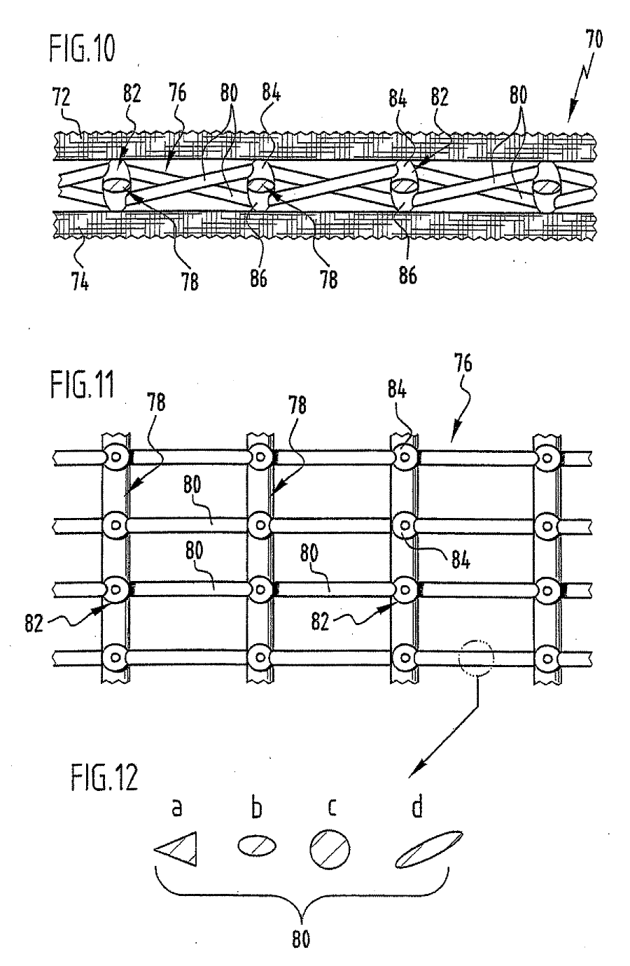

FIG. 12 once again shows possible variants of the cross section of the transverse webs 80, comprising variants a, b, c and d, which have already been discussed in detail in connection with FIG. 3.

### Exemplary Embodiment

When the spacers according to the invention are used in membrane technology for the treatment of industrial process water, the main problem is often a high risk of fouling and scaling on the membrane as a result of organic and inorganic constituents of the water. In this context, it is an essential condition for use of a membrane filter that the module can be cleaned. Consequently, the use of spiral wound-type modules according to the prior art is eminently conceivable for relatively unpolluted water. The cleanability of the membrane is improved when using a spacer according to the invention, for example as shown in FIG. 1. Moreover, the transverse web configuration shown in FIG. 3a realizes flow guidance which reduces the concentration polarization and therefore the risk of blockages. A thickness of the spacer or the spacing of the bearing surfaces, which is defined by the spacer, of from 1 to 2 mm combined with a ratio of the heights of the second and first web regions, measured in the direction of the spacing, of from 1:2 to 1:4 is conceivable here depending on the degree of contamination of the untreated water.

1. A spacer for filter modules, wherein the spacer is disposed between two layers of a filter material, comprising a sheet material having a gridlike structure, and having upper and lower surfaces, the upper and lower surfaces defining an upper and lower bearing face for the layers of filter material, the sheet material being formed by a multiplicity of webs interconnected at junction points, the webs having a first portion disposed parallel to a first preferred direction and a second portion disposed parallel to a second preferred direction, the second preferred direction intersecting the first preferred direction, wherein at least some of the webs have first web regions, extending to the upper and/or lower bearing face(s), and at least a further portion of the webs has second web regions which are spaced from the upper and lower bearing faces, the second web regions extending over substantially the entire length of those webs.

2. The spacer as defined in claim 1 wherein the first web regions extending to the upper and/or lower bearing faces are in the form of elongated fins.

3. The spacer as defined in claim 1 wherein the first web regions extending to the upper and/or lower bearing faces are substantially in the form of punctiform regions.

4. The spacer as defined in claim 3, wherein the first punctiform web regions are disposed at junction points of the webs.

5. The spacer as defined in claim 1, wherein all webs are disposed substantially parallel to the preferred directions.

6. The spacer as defined in claim 1, wherein the first and second preferred directions intersect at an angle of approximately 90°.

7. The spacer as defined in claim 1, wherein the webs over the second web regions, in which they are kept at a distance from the upper or lower bearing face, are noncircular in cross-section.

8. The spacer as defined in claim 1, wherein the second web regions are disposed and/or shaped such that regions of turbulence are produced in the fluid flowing through the filter.

9. The spacer as defined in claim 1, wherein the webs define, with their first web regions bearing against the filter material, flow channels whose cross-section approaches the shape of a rectangle.

10. the spacer as defined in claim 1, wherein the webs having second web regions are disposed at an acute angle to the bearing faces.

11. The spacer as defined in claim 10, wherein the webs disposed at an acute angle to the bearing faces show, at their ends at which they are connected to other webs at junction points, a predetermined distance from the bearing faces.

12. The spacer as defined in claim 1, wherein the second and first web regions have heights, and the ratio of the heights of the second and first web regions ranges from 1:2 to 1:20, these heights being measured in each case at right angles to the bearing faces.

13. The spacer as defined in claim 12, wherein the webs having first web regions have a thickness of up to 10 mm.

14. A filter module comprising two filtering layers and a spacer as defined in claim 1 disposed between the filtering layers.

15. The filter module as defined in claim 14, wherein the spacer is disposed in the filter module such that one of the preferred directions is parallel to the direction of flow of a fluid being filtered by the filter module.

16. The filter module as defined in claim 15, wherein the other of the preferred directions is at right angles to the direction of flow of the fluid being filtered.

17. The filter module as defined in claim 15, wherein the webs having first web regions enclose a smaller angle with the direction of flow than the webs having second web regions.

18. the spiral wound-type module, containing a filter module as defined in claim 14.

19. A stacked module fabricated from two or more filter modules as defined in claim 14.

20. A method of treating industrial waste water comprising passing the industrial waste water through the filter module of claim 14.

21. A method of treating industrial process water comprising passing the industrial process water through the filter module of claim 14.

22. A method of treating leachate from landfills comprising passing the leachate from landfills through the filter module of claim 14.

23. A method of desalinating sea water comprising passing the sea water through the filter module of claim 14.

24. A method of treating surface water comprising passing the surface water through the filter module of claim 14.

25. A method of treating brackish water comprising passing the brackish water through the filter module of claim 14.

26. The method of claim 20, wherein passing the industrial waste water through the filter module comprises passing the water through a spiral wound-type filter module.

27. The method of claim 20, wherein passing the industrial waste water through the filter module comprises passing the water through a stacked module.

28. The spacer as defined in claim 7, wherein the webs over the second web regions are of an oblate shape and are oriented such that the area facing incoming flow is minimized.
